(19) United States
(12) Patent Application Publication
(10) Pub. No.: US 2007/0074245 A1
(43) Pub. Date: Mar. 29, 2007

(54) Virtual channels

(75) Inventors: George K. Nyako, Santa Clara, CA (US); David Hendler Sloo, Menlo Park, CA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/235,537

(22) Filed: Sep. 26, 2005

(51) Int. Cl. H04N 5/445; G06F 13/00; H04N 7/025; H04N 7/10; G06F 3/00

(52) U.S. Cl. 725/34; 725/46; 725/35

(57) ABSTRACT

A request is received to view a virtual television channel. A user associated with the request is identified along with user preferences associated with that user. Content, such as television programs, music, and games, is identified that satisfies the identified user preferences. The identified content is ranked based on the user preferences, which generates highest-ranked content. At least a portion of the highest-ranked content is then displayed.

### BACKGROUND

Users of television systems and other media systems often search for a particular television program or other type of media content. As the number of television channels increases, along with the amount of available content, searching for specific content becomes increasingly difficult and time-consuming. Conventional program guides, such as program guide 100 shown in FIG. 1, use a two-dimensional grid to display program content. The two-dimensional grid has a channel axis and a time axis. In the example of FIG. 1, the channel axis is oriented vertically and the time axis is oriented horizontally. For example, multiple channels 102 are displayed along the channel axis and multiple time periods 104 are displayed along the time axis. Other program guides (not shown) may have a different orientation of channel and time axes, or may arrange program content based on other criteria, such as program topic or whether there is a fee to access the content.

A user navigates along any axis to find the desired content. For example, a user can scroll through the available channels using the up and down arrows in the channel axis. Similarly, the user can scroll through different time periods using the left and right arrows in the time axis. Program guide 100 also displays the date 106 for which program data is displayed. This date 106 can be changed using the right and left arrows adjacent the date. Additionally, program guide 100 displays the current time of day 108.

The example of FIG. 1 may contain hundreds of different channels and hundreds of different time periods over several days. Thus, the user has a very large two-dimensional grid to navigate when attempting to locate desired program. A significant portion of the programs contained in program guide 100 may not be of interest to the user. However, the user must navigate through these unwanted programs to find the desired program. This navigation can be time-consuming and frustrating to the user.

Therefore, it would be desirable to provide a system that generates and displays program information based on viewing preferences of a television user.

### SUMMARY

The systems and methods described herein generate and display content, such as television program information, based on one or more user preferences. A system receives a request to view a virtual television channel. In response to the request, the system identifies a user associated with the request and identifies user preferences associated with that user. The system further identifies content that satisfies the identified user preferences. The identified content is ranked based on the user preferences to generate highest-ranked content. At least a portion of the highest-ranked content is displayed by the system.

In a particular embodiment, the system automatically identifies a highest-ranked upcoming program and records the highest-ranked upcoming program.

In other embodiments, the system communicates the user preferences to other systems for use in identifying content that satisfies the user preferences.

### BRIEF DESCRIPTION OF THE DRAWINGS

Similar reference numbers are used throughout the figures to reference like components and/or features.

FIG. 1 illustrates an example of a conventional program guide displaying television program information.

FIG. 2 illustrates an example system that allows a television user to search for and view available program content.

FIG. 3 is a flow diagram illustrating an embodiment of a procedure for displaying a virtual channel.

FIGS. 4A and 4B illustrate example displays of program information associated with multiple channels.

FIG. 5 is a flow diagram illustrating an embodiment of a procedure for modifying user preferences.

FIG. 6 is a flow diagram illustrating an embodiment of a procedure for automatically recording programs based on user preferences.

FIG. 7 illustrates various components of an example client device in which the systems and methods discussed herein can be implemented.

FIG. 8 illustrates various devices and components in an example entertainment and information system in which the systems and methods discussed herein can be implemented.

### DETAILED DESCRIPTION

The systems and methods described herein generate and display content, such as television program information, based on one or more user preferences. The content may be displayed via a virtual channel (also referred to as a “virtual television channel”, “personalized channel”, or “personalized television channel”). The virtual channel may include information regarding television programs from multiple different channels and multiple different sources as well as other content such as music, images, advertisements, games, and the like. The content is ranked based on how closely the content characteristics satisfy the user preferences. User preferences include, for example, program name, program category, actors, directors, program rating, music genre, game type, and one or more keywords contained in the description of the content. Advertisements may be targeted to particular users based on their user preferences. Additionally, content that satisfies the user preferences may be recorded automatically for future access by the user.

Particular examples discussed herein refer to specific components in a television environment. A television environment includes any one or more systems or methods related to, for example, processing video data, image data, audio data, or other entertainment-related data. However, the systems and methods discussed herein may be utilized with other components contained in similar or different operating environments.

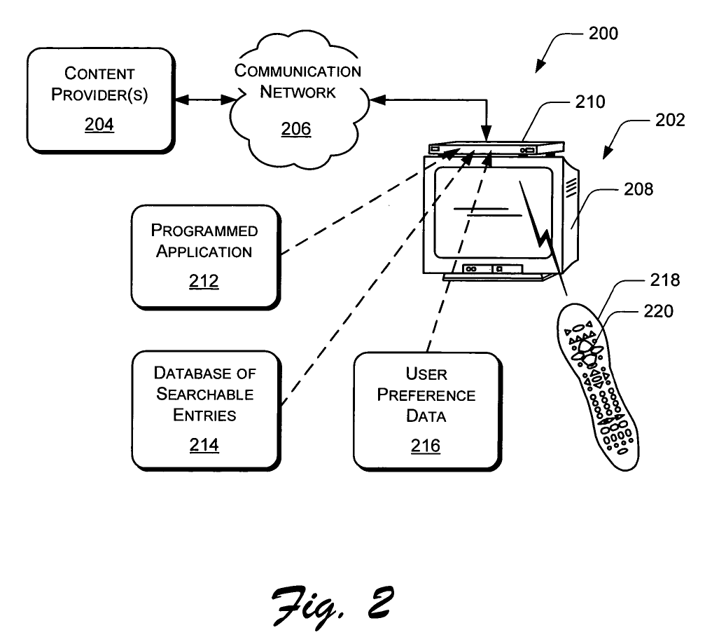

FIG. 2 illustrates an example system 200 that allows a television user to search for and view available program content. In this example, the system 200 includes a television-based client system 202 configured for data communication with any number of content provider(s) 204 via a communication network 206, which in this example, is an Internet Protocol (IP)-based network. The embodiments described herein can also be implemented in any television-based system using any type of content distribution mechanism. The client system 202 receives program content, various forms of media content, television programs, movies, program guide data, advertising content, and the like from content server(s) of the content provider(s) 204 via the communication network 206.

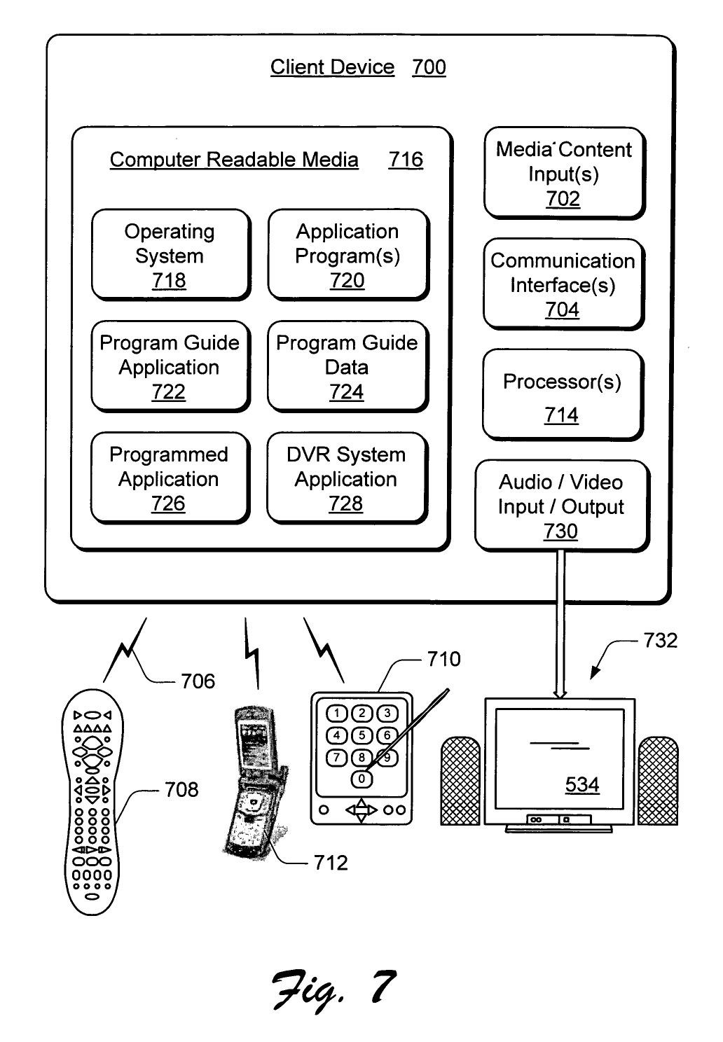

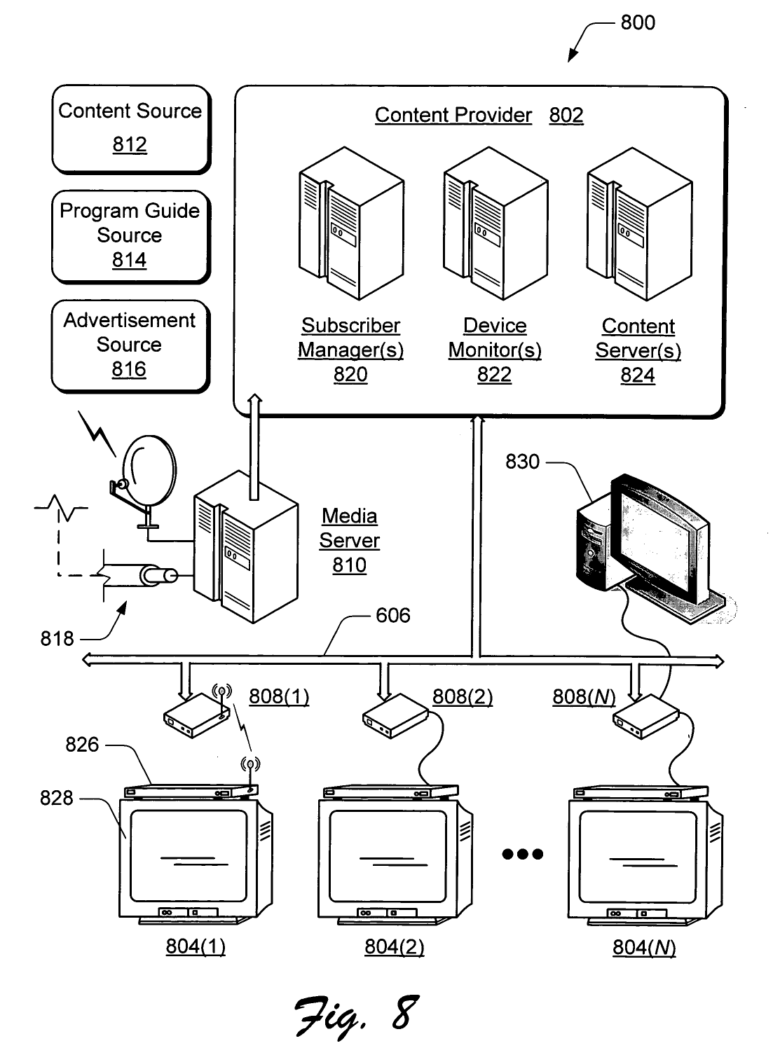

The television-based client system 202 includes a display device 208 (e.g., a television, LCD display, or the like) and a client device 210. Client device 210 can be implemented in any number of embodiments, such as a set-top box, a digital video recorder (DVR) and playback system, a personal video recorder (PVR), an appliance device, a gaming system, any combination thereof, and as any other type of client device that may be implemented in a television-based entertainment and information system. In one embodiment, client device 210 can be implemented with any one or combination of the components described with reference to client device 700 shown in FIG. 7. Further, any combination of the components described with reference to system 200 can be implemented in the example television-based system 800 that includes examples of both a network-based content provider and television-based client devices as described with reference to FIG. 8.

In the example of FIG. 2, client device 210 includes a programmed application 212 that can be programmed to implement the various features and embodiments described herein. Although the programmed application 212 is illustrated and described as a single application, the programmed application 212 can be implemented as several component applications distributed to each perform one or more functions in client device 210.

Client device 210 also includes a database of searchable entries 214 that correspond to various applications, movies, television programs, music, and other audio, video, and/or image content that may be recorded or available via content provider 204, and that a user of the television-based client system 202 may want to access. In one embodiment the database of searchable entries 214 may be information that is included in the program guide data received from content providers 204. In an alternate embodiment, the information may be independent from the program guide data. The database of searchable entries 214 may also include any accessible information that may be available via an IPTV (Internet Protocol Television) system, such as the television-based system 800 described with reference to FIG. 8.

Client device 210 further includes user preference data 216 that contains one or more user preference parameters. Example user preferences include program name, program category, actors, directors, program rating, and one or more keywords contained in the description of the program. Additional details regarding user preference data 216 are provided herein.

A user can input television commands, a sequence of characters, and the like with an input device, such as television remote control 218 that has various keys 220. Example keys 220 include search and navigation keys that allow a user to select characters and to navigate through a program guide or other information display. Alternatively, a user may enter characters or commands to client device 210 with a cellular phone, PDA, or other input device that can be configured to operate as a television remote control device.

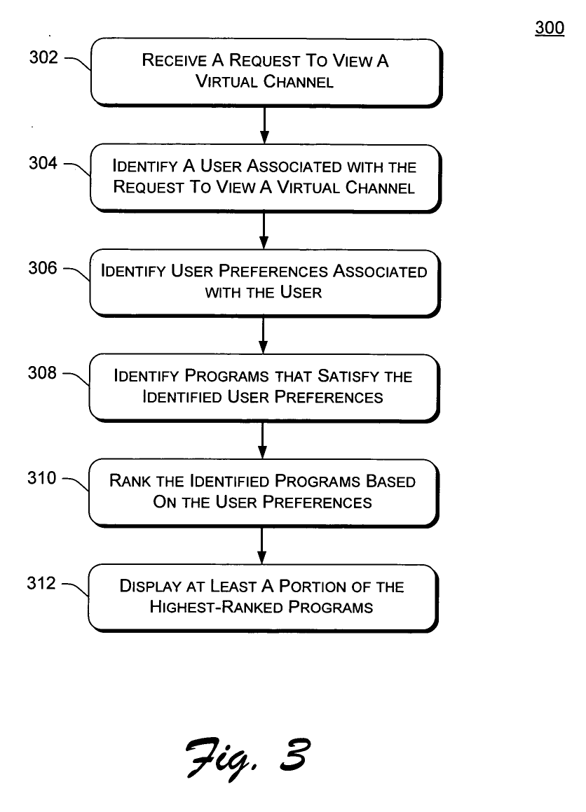

FIG. 3 is a flow diagram illustrating an embodiment of a procedure 300 for displaying a virtual channel. Initially, procedure 300 receives a request to view a virtual channel (block 302). A virtual channel contains a listing of programs and other content that satisfy various preferences set by a user. Thus, the virtual channel contains programs and other content that the user would most likely want to access at a given time. The virtual channel may aggregate programs from multiple different channels (e.g., broadcast channels, video on demand (VoD), IPTV channels, and the like). Additionally, the virtual channel may contain other content, such as music, images, games, event reminders from a personal calendar, and the like. Although particular examples discussed herein relate to virtual channels having program content, a virtual channel may aggregate any type of content or data received from any number of different sources via any communication mechanism.

A particular user may define multiple virtual channels by defining multiple sets of user preferences. Each virtual channel can display different content based on the different preferences associated with each virtual channel. The preferences associated with one virtual channel can be modified without affecting the preferences associated with other virtual channels.

Procedure 300 continues by identifying a user associated with the request to view a virtual channel (block 304). For example, the user may identify themselves by logging into a client device or other system. Next, procedure 300 identifies user preferences associated with the identified user (block 306). User preferences may include any number of different parameters associated with program content. User preferences can be created by a television user, a device manufacturer, a broadcaster, a content provider, or any other individual or entity. For example, television users can manually customize content rankings by ordering them in a list. Additionally, users can rank content parameters and then assign weights to each parameter. These weights are used in ranking content as discussed below. The weights assigned to each parameter may be referred to as “weighting factors”. Additionally a weight or weighting factor may be assigned to the group of parameters associated with a user preference. For example, the weights associated with each parameter in the group may be added together or the weights may be averaged to determine a group weight or group weighting factor.

The procedure continues by identifying programs that satisfy the identified user preferences (block 308). Programs may be identified using the database of searchable entries discussed above with respect to FIG. 2. Programs may also be identified via one or more content providers or other data sources. After the programs have been identified, procedure 300 ranks the identified programs based on the user preferences (block 310). Programs can be ranked based on how closely the program parameters satisfy the user preferences. For example, if one program matches a preferred program category, a preferred program director, and a preferred actor, that program will be ranked ahead of another program that only matches a preferred program category and a preferred program director. In particular embodiments, different program parameters in the user preference settings may have a stronger weighting than other parameters. In this embodiment, an overall “score” or “matching strength” is calculated and used to rank multiple programs that satisfy the user preferences. After ranking the identified programs, at least a portion of the highest-ranked programs are displayed (block 312). If the client device is unable to display all of the highest-ranked programs on the display device simultaneously (e.g., due to the size of the display device), the client device initially displays a portion of the highest-ranked programs. The user can then scroll or navigate through the entire set of highest-ranked programs and other lower-ranked programs.

In one embodiment, when a user ranks program content, they can rank their favorite actors, directors, genre, content rating, etc. Users then rank each category in a separate list—such as specifying that actors are more important than directors and genre is more important than the content rating. This preference information is used in ranking multiple programs or other content. For example, a user may rank content from a personal calendar (such as event reminders) ahead of a television program or music content, and rank educational programs ahead of comedy programs. Additionally, when a user is viewing a program (or accessing other content) they can select an “add to preferences” button displayed on the screen to add the information associated with the program to the user's preferences. If the user has multiple sets of preferences, the user is prompted as to which preference (or preferences) should receive the information.

In another embodiment, the systems and methods discussed herein track a user's viewing history and generate user preference parameters based on that viewing history. For example, if the user regularly watches football or movies with a particular actor, those characteristics become user preference parameters. Those parameters are used in generating virtual channels, automatically recording various content, and performing targeted advertising as discussed herein.

In a particular implementation, programs and other content listed on a virtual channel will display information regarding the original channel or source from which the content originated. For example, “Scrubs” on channel 5 KRON is displayed on a virtual channel as “5 KRON: Scrubs”. When the user selects a particular program to view or record, the system tunes to the original channel associated with the selection.

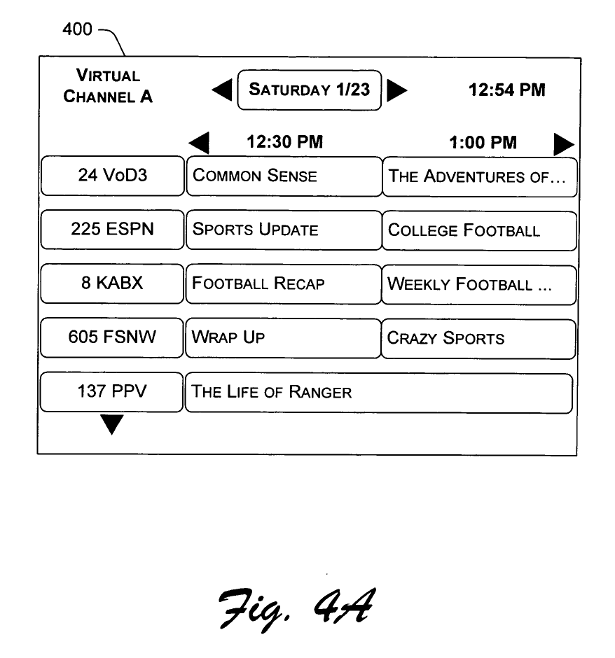

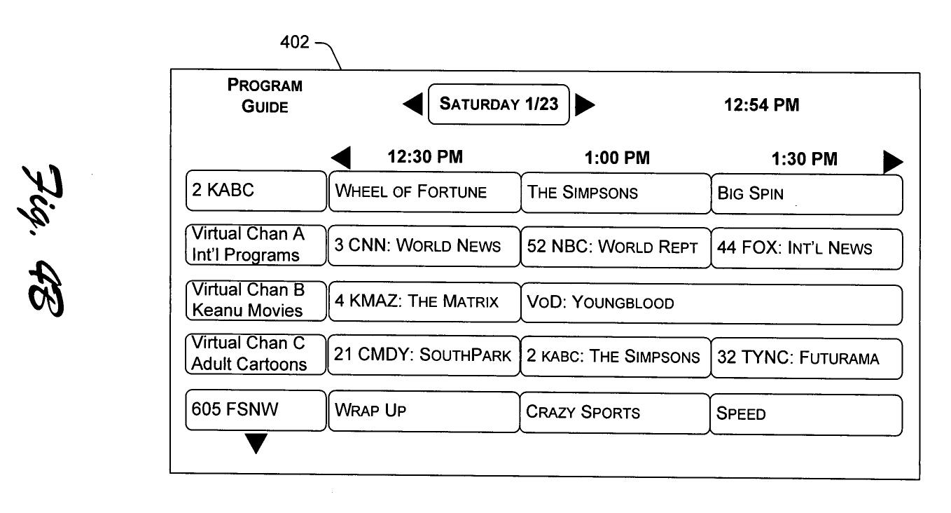

FIGS. 4A and 4B illustrate example displays 400, 402 of program information associated with multiple channels. In FIG. 4A, display 400 is similar to a conventional program guide, but displays programs satisfying the user preferences, and displays those programs in rank order. Rather than displaying all available programs like a traditional program guide, display 400 includes information associated with programs satisfying the preferences of the television user. Also, rather than displaying programs in numerical (or alphabetical) order, the programs are displayed based on how closely they match the user preferences. In display 400, the program “Common Sense” has the closest match to the user preferences, followed by “Sports Update”, and so on. Although only five channels are shown in display 400, the user can scroll down through the listing to lower-ranked programs. As shown in FIG. 4A, the top-left corner of display 400 identifies the virtual channel being displayed (Virtual Channel A in this example).

Display 400 is dynamically generated and may change at different times of the day. For example, the current program ranking shown in FIG. 4A may change at 1:00 PM when a different set of programs begin. Since the ranking of programs is generally based on the characteristics of the program itself instead of the channel number or the channel name, the ranking of the programs starting at 1:00 PM may be significantly different than those shown in FIG. 4A. For example, the program “Crazy Sports” may not satisfy any of the user preferences and will not be included in the virtual channel programs displayed at 1:00 PM. Instead, other programs associated with channels that may not be shown in FIG. 4A will be displayed as part of the virtual channel.

In another embodiment, the display shown in FIG. 4A does not include the time data “12:30 PM” and “1:00 PM”. Instead, the display identifies only the programs that meet the user preferences (e.g., “Common Sense”, “Sports Update”, “Football Recap”, “Wrap Up”, and “The Life of Ranger”). The start time and end time of each program may be included after the program title. Alternately, other program information (e.g., rating or genre) may be displayed near the program title. In other embodiments, the display may include other types of content that satisfies the user preferences, such as games, music, and images.

In FIG. 4B, display 402 includes programs satisfying the user preferences, but displays those programs in a different manner from display 400 shown in FIG. 14A. In display 402, top-ranked programs associated with multiple virtual channels (Virtual Channel A, Virtual Channel B, and Virtual Channel C) and multiple non-virtual channels (e.g., broadcast channels) are displayed simultaneously. For programs associated with a virtual channel, the title of the program is displayed along with the source of the program (e.g., channel number, VoD, or pay-per-view). Additionally, the title or description of each virtual channel is displayed, such as “Adult Cartoons” for Virtual Channel C. As shown in FIG. 4B, scheduled programs (i.e., programs that begin at a specified time) are displayed along with unscheduled programs, such as on-demand programs that are accessible at any time. On-demand content includes, for example, programs stored in a video library, music video tracks stored in an album database, or recorded television programs stored on a client device.

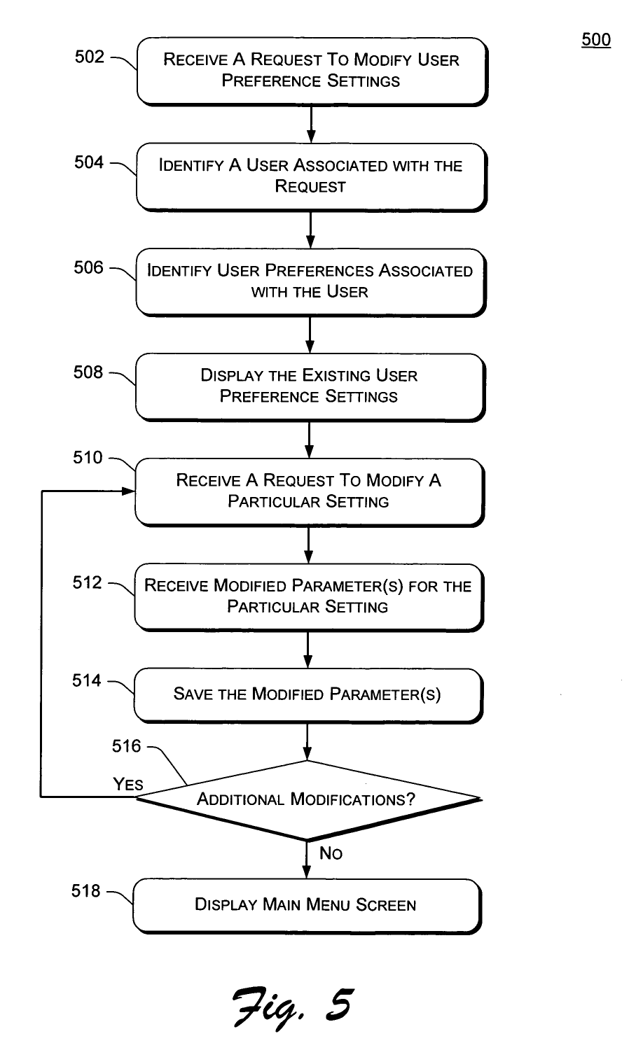

FIGS. 4A and 4B represent example displays of content based on user preferences. Alternate displays may be arranged in any manner to display any type of information related to one or more different types of content. FIG. 5 is a flow diagram illustrating an embodiment of a procedure 500 for modifying user preferences. Initially, procedure 500 receives a request to modify user preference settings (block 502). The procedure then identifies a user associated with the request (block 504) and identifies user preferences associated with the user (block 506). Procedure 500 continues by displaying the existing user preference settings (block 508). A request is received to modify a particular setting (block 510). The procedure then receives one or more modified parameters for the particular setting (block 512). The modified parameters can be modified, for example, by entering values using keys on a remote control device, by scrolling through a list of available settings, or changing the ranking of a group of parameters. For example, a particular setting ranks various broadcast channels based on the user's preference for viewing those channels. The user can change the ranking of the various broadcast channels by promoting (i.e., increasing the ranking) or demoting (i.e., decreasing the ranking) one or more channels. Other settings may contain multiple ranked values, such as actor names, director names, program categories, and the like.

After receiving the modified parameters, procedure 500 saves the modified parameters (block 514). The procedure then determines whether there are additional modifications desired (block 516). If so, the procedure returns to block 510 to receive additional modifications to a particular settings. If there are no additional modifications, a main menu screen is displayed to the user (block 518), indicating that the modifications to the user preference settings are complete.

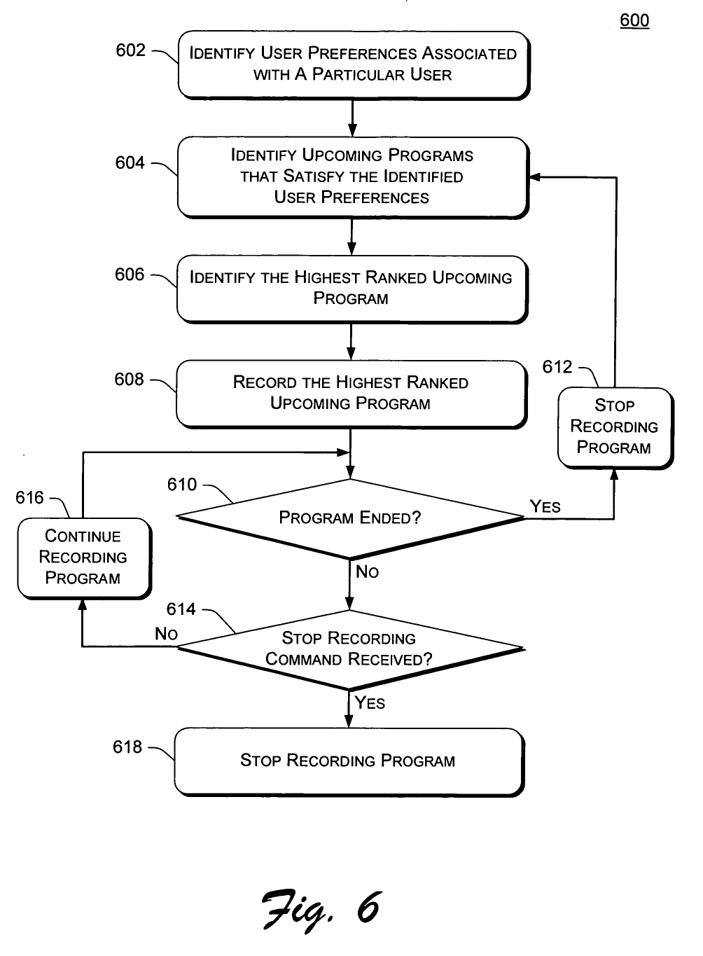

FIG. 6 is a flow diagram illustrating an embodiment of a procedure 600 for automatically recording programs based on user preferences. Procedure 600 begins by identifying user preferences associated with a particular user (block 1602). For example, the particular user can be the user that requested the automatic recording of programs. Procedure 600 continues by identifying upcoming programs that satisfy the identified user preferences (block 604). The procedure then identifies the highest ranked upcoming program (block 606). The highest ranked upcoming program is the upcoming program that most closely satisfies the user preferences. The highest ranked upcoming program is recorded upon reaching the program's scheduled start time (block 608).

Procedure 600 continues by determining whether the program (i.e., the highest ranked program currently being recorded) has ended (block 610). If so, the procedure stops recording the program (block 612) and returns to block 604 to identify other upcoming programs that satisfy the identified user preferences. If the program has not ended, the procedure determines whether a “stop recording” command has been received (block 614). If a “stop recording” command has not been received, the procedure continues recording the program (block 616) and returns to block 610 to determine whether the program has ended. If a “stop recording” command is received, the procedure stops recording the program (block 618) and awaits further commands.

Although not shown in FIG. 6, various procedures may be used to control the number of programs recorded automatically and to delete previously recorded programs as needed to provide storage space for current programs. For example, the amount of storage space available for automatically recorded programs may be limited to prevent all of the storage space from being used by the automatically recorded programs. Furthermore, there may be limits on the number of programs automatically recorded each day. For example, a system may be limited (by the manufacturer or by the user) to record only the two highest ranked programs in a particular day.

In a particular implementation, a system may automatically record programs that exceed a particular preference weight threshold specified by the user (or other individual or entity). Adjusting the preference weight threshold affects the number of programs that satisfy the threshold and, therefore, are automatically recorded. Alternatively, a user may specify that, for example, only the top 2% (based on preference weight) of shows that satisfy the user preferences are automatically recorded.

In one embodiment, user preferences are stored in a file, database, or other data structure. As discussed herein, a particular user can have multiple different user preferences, each associated with a different virtual channel. These multiple user preferences are stored, for example, in separate files with unique file names. These file names are also used as the virtual channel name. Example file names include “mystery movies”, “football lover”, “James Dean fan”, “Children's Educational”, and the like. Descriptive file names allow a user to quickly select a desired virtual channel based on the name rather than looking at the preference settings to determine the type of programs likely to be selected by the virtual channel.

The user preference files discussed above can be shared among different users. Additionally, an organization may provide various user preference templates that can be further modified by particular users to meet their desires. For example, user preference files may be available for download from an organization or may be shared via email or any other mechanism for transferring files from one user to another. Thus, if one user develops a user preference file titled “my favorite mystery movies”, that user can share that user preference file with friends and family who will find similar (or identical) program content when used in their own television environment. Thus, groups of people using the same user preference files will identify similar program content by using similar user preference settings. Program content may vary from one system to another if, for example, users receive content from different content providers (using different cable or satellite services) or have different premium channel subscriptions.

In another implementation, user preference information can be useful in determining a user's interests. Content providers or other entities may use this user preference information to target advertisements or other information that is likely to be of high interest to the user. Advertisements may be displayed as on-demand programs in the virtual channel and can be interactive. Targeted advertising may also be displayed as a content entry. For example, a user watching a virtual channel tailored to mountain climbing can be targeted with interactive on-demand advertisements that allow the user to purchase climbing gear immediately with one click of a button.

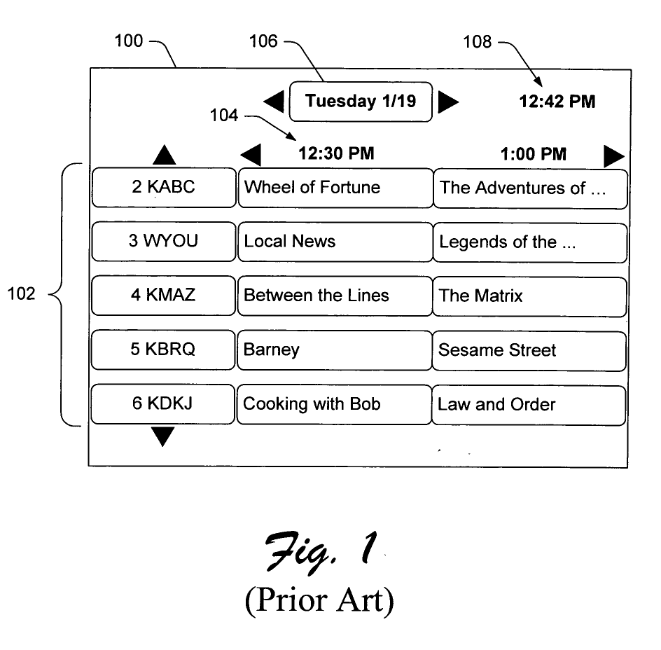

FIG. 7 illustrates various components of an exemplary client device 700 which can be implemented as any form of a computing, electronic, and/or television-based client device, and in which the systems and methods discussed herein can be implemented. For example, the client device 700 can be implemented as the television-based client device 210 shown in FIG. 1 as part of the television-based client system 202.

Client device 700 includes one or more media content inputs 702 which may include Internet Protocol (IP) inputs over which streams of media content are received via an IP-based network. Device 700 further includes communication interface(s) 704 which can be implemented as any one or more of a serial and/or parallel interface, a wireless interface, any type of network interface, a modem, and as any other type of communication interface. A wireless interface enables client device 700 to receive control input commands 706 and other information from an input device, such as from remote control device 708, PDA (personal digital assistant) 710, cellular phone 712, or from another infrared (IR), 802.11, Bluetooth, or similar RF input device.

A network interface provides a connection between the client device 700 and a communication network by which other electronic and computing devices can communicate data with device 700. Similarly, a serial and/or parallel interface provides for data communication directly between client device 700 and the other electronic or computing devices. A modem facilitates client device 700 communication with other electronic and computing devices via a conventional telephone line, a DSL connection, cable, and/or other type of connection.

Client device 700 also includes one or more processors 714 (e.g., any of microprocessors, controllers, and the like) which process various computer executable instructions to control the operation of device 700, to communicate with other electronic and computing devices, and to implement the embodiments described herein. Client device 700 can be implemented with computer readable media 716, such as one or more memory components, examples of which include random access memory (RAM), non-volatile memory (e.g., any one or more of a read-only memory (ROM), flash memory, EPROM, EEPROM, etc.), and a disk storage device. A disk storage device can include any type of magnetic or optical storage device, such as a hard disk drive, a recordable and/or rewriteable compact disc (CD), a DVD, a DVD+RW, and the like.

Computer readable media 716 provides data storage mechanisms to store various information and/or data such as software applications and any other types of information and data related to operational aspects of client device 700. For example, an operating system 718 and/or other application programs 720 can be maintained as software applications with the computer readable media 716 and executed on processor(s) 714 to implement the systems and methods discussed herein.

For example, client device 700 can be implemented to include a program guide application 722 that is implemented to process program guide data 724 and generate program guides for display which enable a user to navigate through an onscreen display and locate broadcast programs, recorded programs, video on-demand programs and movies, interactive game selections, network-based applications, and other media access information or content of interest to the user. The computer readable media 716 can also include a programmed application 726 to implement features and embodiments described herein. The computer readable media 716 can also include a DVR system application 728 to maintain and playback recorded media content.

Although the programmed application 726 is illustrated and described as a single application configured to implement embodiments described herein, the programmed application 726 can be implemented as several component applications distributed to each perform one or more functions in a client device in a television-based entertainment and information system. Further, the program guide application 722 may include the programmed application 726 as an integrated module or component.

The client device 700 also includes an audio and/or video output 730 that provides audio and video to an audio rendering and/or display system 732, or to other devices that process, display, and/or otherwise render audio, video, and display data. Video signals and audio signals can be communicated from device 700 to a television 734 (or to other types of display devices) via an RF (radio frequency) link, S-video link, composite video link, component video link, analog audio connection, or other similar communication link.

FIG. 8 illustrates an exemplary entertainment and information system 800 in which an IP-based television environment can be implemented, and in which embodiments discussed herein can be implemented. System 800 facilitates the distribution of program content, program guide data, and advertising content to multiple users. System 800 includes a content provider 802 and television-based client systems 804(1-N) each configured for communication via an IP-based network 806.

The network 806 can be implemented as a wide area network (e.g., the Internet), an intranet, a Digital Subscriber Line (DSL) network infrastructure, or as a point-to-point coupling infrastructure. Additionally, network 806 can be implemented using any type of network topology and any network communication protocol, and can be represented or otherwise implemented as a combination of two or more networks. A digital network can include various hardwired and/or wireless links 808(1-N), routers, gateways, and so on to facilitate communication between content provider 802 and the client systems 804(1-N). The television-based client systems 804(1-N) receive program content, program guide data, advertising content, closed captions data, and the like from content server(s) of the content provider 802 via the IP-based network 806.

System 800 includes a media server 810 that receives program content from a content source 812, program guide data from a program guide source 814, and advertising content from an advertisement source 816. In an embodiment, the media server 810 represents an acquisition server that receives the audio and video program content from content source 812, an EPG server that receives the program guide data from program guide source 814, and/or an advertising management server that receives the advertising content from the advertisement source 816.

The content source 812, the program guide source 814, and the advertisement source 816 control distribution of the program content, the program guide data, and the advertising content to the media server 810 and/or to other television-based servers. The program content, program guide data, and advertising content is distributed via various transmission media 818, such as satellite transmission, radio frequency transmission, cable transmission, and/or via any number of other wired or wireless transmission media. In this example, media server 810 is shown as an independent component of system 800 that communicates the program content, program guide data, and advertising content to content provider 802. In an alternate implementation, media server 810 can be implemented as a component of content provider 802.

Content provider 802 is representative of a headend service in a television-based content distribution system, for example, that provides the program content, program guide data, and advertising content to multiple subscribers (e.g., the television-based client systems 804(1-N)). The content provider 802 can be implemented as a satellite operator, a network television operator, a cable operator, and the like to control distribution of program and advertising content, such as movies, television programs, commercials, music, and other audio, video, and/or image content to the client systems 804(1-N).

Content provider 802 includes various components to facilitate media data processing and content distribution, such as a subscriber manager 820, a device monitor 822, and a content server 824. The subscriber manager 820 manages subscriber data, and the device monitor 822 monitors the client systems 804(1-N) (e.g., and the subscribers), and maintains monitored client state information.

Although the various managers, servers, and monitors of content provider 802 (to include the media server 810 in one embodiment) are illustrated and described as distributed, independent components of content provider 802, any one or more of the managers, servers, and monitors can be implemented together as a multi-functional component of content provider 802. Additionally, any one or more of the managers, servers, and monitors described with reference to system 800 can implement the features and embodiments discussed herein.

The television-based client systems 804(1-N) can be implemented to include a client device 826 and a display device 828 (e.g., a television). A client device 826 of a television-based client system 804 can be implemented in any number of embodiments, such as a set-top box, a digital video recorder (DVR) and playback system, a personal video recorder (PVR), an appliance device, a gaming system, and as any other type of client device that may be implemented in a television-based entertainment and information system. In an alternate embodiment, client system 804(N) is implemented with a computing device 830 as well as a client device 826. Additionally, any of the client devices 826 of a client system 804 can implement the features and embodiments described herein.

Although the description above uses language that is specific to structural features and/or methodological acts, it is to be understood that the invention defined in the appended claims is not limited to the specific features or acts described. Rather, the specific features and acts are disclosed as exemplary forms of implementing the invention.

1. A method comprising:
receiving a request to view a virtual television channel;
identifying a user associated with the request;
identifying user preferences associated with the user;
identifying content that satisfies the identified user preferences;
ranking the identified content based on the user preferences to generate highest-ranked content; and
displaying at least a portion of the highest-ranked content.

2. A method as recited in claim 1 wherein the user preferences are defined by the user.

3. A method as recited in claim 1 wherein identifying content includes aggregating content from a plurality of sources.

4. A method as recited in claim 1 wherein the content includes a plurality of television programs.

5. A method as recited in claim 1 wherein identifying content includes aggregating a plurality of programs from a plurality of television channels.

6. A method as recited in claim 1 wherein ranking the identified content includes applying weighting factors to user preference parameters.

7. A method as recited in claim 1 further comprising:
receiving a content selection; and
tuning to the channel associated with the selected content.

8. A method as recited in claim 1 further comprising generating targeted advertising based on the user preferences.

9. A method as recited in claim 8 further comprising displaying the targeted advertising as a content entry.

10. A method as recited in claim 1 further comprising communicating the identified user preferences to a plurality of television environments.

11. A method comprising:
identifying user preferences in a television environment, wherein the user preferences are defined by a particular user;
identifying upcoming programs that satisfy the identified user preferences;
identifying the highest-ranked upcoming program; and
recording the highest-ranked upcoming program.

12. A method as recited in claim 11 wherein the identified user preferences include at least one of program genre, program rating, or program title.

13. A method as recited in claim 11 wherein identifying upcoming programs includes identifying programs from multiple different sources.

14. A method as recited in claim 11 wherein identifying upcoming programs includes identifying on-demand content.

15. A method as recited in claim 11 further comprising:
generating targeted advertising based on the user preferences; and
recording the targeted advertising with the highest-ranked upcoming program.

16. One or more computer readable media having stored thereon a plurality of instructions that, when executed by one or more processors, causes the one or more processors to:
identify user preferences in a television environment;
store the identified user preferences in a data file; and
communicate the data file to a destination device, wherein the destination device identifies content that satisfies the user preferences in the data file and displays at least a portion of the identified content.

17. One or more computer readable media as recited in claim 16, wherein the destination device is a second television environment associated with a second user.

18. One or more computer readable media as recited in claim 16, wherein the user preferences are defined by a content provider and communicated to a plurality of television environments.

19. One or more computer readable media as recited in claim 16, wherein the one or more processors further:
identify advertisements based on the identified user preferences; and
display the identified advertisements in the television environment.

20. One or more computer readable media as recited in claim 16, wherein the user preferences are associated with a particular user of the television environment.
